(19) United States
(12) Patent Application Publication
(10) Pub. No.: US 2006/0092029 A1
(43) Pub. Date: May 4, 2006

(54) Powering down a portable medical device after a data transmission

(76) Inventors: David W. Browne, Sammamish, WA (US); Dana J. Olson, Kirkland, WA (US)

Correspondence Address: SHUMAKER & SIEFFERT, P. A., 8425 SEASONS PARKWAY, SUITE 105, ST. PAUL, MN, 55125, US

(21) Appl. No.: 10/977,331

(22) Filed: Oct. 29, 2004

(51) Int. Cl. G08B 23/00

(52) U.S. Cl. 340/573.1

(57) ABSTRACT

A portable medical device, such as an external defibrillator, transmits data to another device, such as a computer. The portable medical device determines when the data transmission has ended, and automatically powers down after data transmission has ended. For example, the portable medical device may receive a signal from the other device, which is generated by the other device to acknowledge receipt of the complete data transmission from the portable medical device, and power down in response to receipt of the signal. In some embodiments, the portable medical device also determines whether it is appropriate to automatically power down after the data transmission has ended, and powers down based on this determination. For example, the portable medical device may determine that it is currently being used to treat a patient, in which case powering down may be inappropriate.

### TECHNICAL FIELD

The invention relates to portable medical devices and, more particularly, to portable medical devices that transmit data to other devices.

### BACKGROUND

An external defibrillator delivers energy to a heart of a patient via electrodes placed upon the patient's chest. Often, external defibrillators are used to deliver energy in the form of a defibrillation pulse to a heart that is undergoing ventricular fibrillation and has lost its ability to contract. Ventricular fibrillation is particularly life threatening because activity within the ventricles of the heart is so uncoordinated that virtually no pumping of blood takes place. If untreated, the patient whose heart is undergoing fibrillation may die within a matter of minutes.

An electrical pulse delivered to a fibrillating heart may depolarize the heart and cause it to reestablish a normal sinus rhythm. In some cases, the patient may need multiple pulses, and the external defibrillator may deliver different quantities of energy with each defibrillation pulse. Further, the defibrillator may provide additional or alternative therapies to the patient, such as cardioversion or pacing therapy.

The defibrillator may also monitor the patient via the electrodes, and generate a record of the condition and treatment of the patient. For example, the defibrillator may record an electrocardiogram (ECG) of the patient sensed via the electrodes. The defibrillator may keep track of the therapy provided to the patient by, for example, recording the types and energy levels of defibrillation pulses delivered to the patient and the time at which these pulses were delivered. The defibrillator may also include a microphone to make an audio recording of the treatment of the patient. These and other types of information surrounding the treatment of the patient, i.e., medical event information, may be stored within a memory of the defibrillator.

In some cases, after the patient has been treated, the defibrillator transmits the medical event information to another device, such as a central station, archive server, or other type of computer. The computer may be used to create a report of the treatment of the patient, sometimes referred to as an incident or “run” report, based on the medical event information. Such reports may be used to evaluate the timeliness of the response to the medical emergency involving the patient, and the efficacy of the treatment provided to the patient. Further, one or both of the medical event information and such a report may become part of the medical records for the patient.

### SUMMARY

In general, the invention is directed to techniques for automatically powering down a portable medical device, such as an external defibrillator, after the portable medical device transmits data to another device, such as a computer. The transmission of data, such as medical event information, from a portable medical device to another device may require a significant amount of time. For example, transmission of data, including an audio recording, for a medical event lasting one hour may take three to seven minutes, depending on the data transmission rate.

Typically, such data transmissions occur at a location where the portable medical device is stored, but which is not where the user of the portable medical device would prefer to be after treatment of a patient. For example, an external defibrillator may transmit medical event information to a computer for generation of a run report when the defibrillator has been returned to a garage in which defibrillators and ambulances are stored between emergency calls. The computer may be located in the garage, or located remotely from the portable medical device. Whereas a user of a conventional external defibrillator may prefer to immediately retire to a break room, or the like, after responding to a medical emergency, the user must instead wait in the garage for completion of the data transmission in order to power down the conventional defibrillator when the data transmission is complete. If the user leaves the conventional defibrillator during the data transmission, the user must remember to return to the garage to power down the defibrillator. Defibrillators should be powered down upon or shortly after completion of data transmission to avoid unnecessary depletion of the power source, e.g., battery, of the defibrillator, which may leave the defibrillator unable to respond to a next medical emergency.

Unlike conventional portable medical devices, a portable medical device according to the invention determines when a data transmission to another device has ended, and automatically powers down after data transmission has ended. For example, the portable medical device may receive a signal from the other device, which is generated by the other device to acknowledge receipt of the complete data transmission from the portable medical device, and power down in response to receipt of the signal. The portable medical device may power down immediately upon determining that the data transmission has ended, or delay powering down for an interval after determining that the data transmission has ended. In some embodiments, the portable medical device may provide an alarm during the delay interval to notify a user that the medical device will automatically power down at the end of the delay interval. Further, the portable medical device may not automatically power down if an override command is received from a user during the delay interval. Powering down a portable medical device may include powering off the portable medical device, or placing the portable medical device in a lower power state, e.g., a non-treatment state in which system diagnostic functions may be performed.

In some embodiments, the portable medical device also determines whether it is appropriate to automatically power down after the data transmission has ended, and powers down based on this determination. For example, the portable medical device may automatically power down after a data transmission only if it is not currently used to treat a patient. The portable medical device may determine whether it is currently being used to treat a patient by, for example, determining whether it is in a treatment mode, rather than an archive mode, or by determining whether it is connected to a patient, e.g., via electrodes.

In other embodiments, the portable medical device may receive an input from a user prior to the end of the data transmission directing the device to power down at the end of the data transmission. For example, the portable medical device may prompt the user via a graphical user interface to indicate whether the device should power down at the end of the data transmission. The portable medical device may prompt the user prior to the data transmission, and begin the data transmission after receiving a response to the prompt from the user.

In one embodiment, the invention is directed to a method comprising transmitting data from a memory of a portable medical device to another device, determining whether the data transmission has ended, and automatically powering down the portable medical device based on the determination.

In another embodiment, the invention is directed to a portable medical device comprising a memory that stores data, communication circuitry, and a processor. The processor controls the communication circuitry to transmit data from the memory to another device, determines whether the data transmission has ended, and automatically powers down the portable medical device based on the determination.

In another embodiment, the invention is directed to a computer-readable medium containing instructions. The instructions cause a programmable processor to control transmission of data from a memory of a portable medical device to another device, determine whether the data transmission has ended, and automatically power down the portable medical device based on the determination.

In another embodiment, the invention is directed to a portable medical device comprising means for transmitting data from a memory of a portable medical device to another device, means for determining whether the data transmission has ended, and means for automatically powering down the portable medical device based on the determination.

The invention may provide advantages. For example, because it may automatically power down after a data transmission has ended, a portable medical device according to the invention may be left unattended during the data transmission without concern that its power source will be unnecessarily depleted. In embodiments in which the portable medical device transmits data to a computer for generation of reports or the like, the computer may be located some distance from the place where the medical device is stored, and the user may immediately leave the medical device to work with the transmitted data at the computer. The computer may be wirelessly connected to the portable medical device, and located in a setting that is more comfortable for the user than the storage location of the portable medical device, such as a break room or office. Additionally, by determining whether it is being used to treat a patient, prompting a user for input indicating whether to power down, delaying an interval after the end of the data transmission, and/or providing an alarm during the delay interval, the portable medical device may avoid powering down at an inappropriate time.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example environment in which an external defibrillator transmits data to a computer.

FIG. 2 is a block diagram further illustrating the external defibrillator of FIG. 1.

FIG. 3 is a flow diagram illustrating an example method for determining whether to automatically power down after a data transmission that may be performed by the defibrillator of FIGS. 1 and 2.

FIG. 4 is a flow diagram illustrating another example method for determining whether to automatically power down after a data transmission that may be performed by the defibrillator of FIGS. 1 and 2.

### DETAILED DESCRIPTION

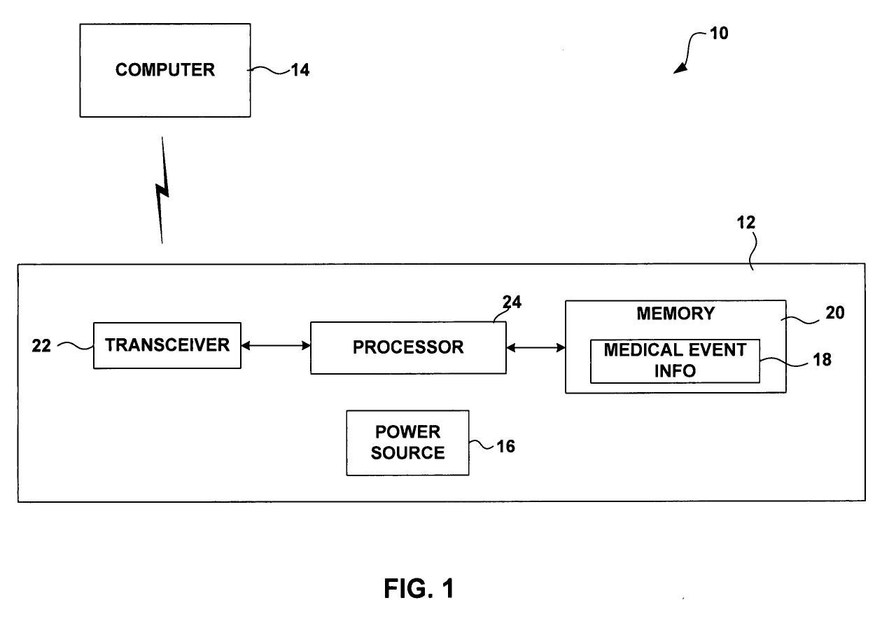

FIG. 1 is a block diagram illustrating an example environment 10 in which an external defibrillator 12 transmits data to another device, such as a vital signs monitor, another defibrillator, or computer 14. Defibrillator 12 is an example of a portable medical device that automatically powers down after a data transmission has ended, in accordance with an embodiment of the invention. In particular, as will be described in greater detail below, defibrillator 12 determines when the transmission of data to computer 14 has ended, and automatically powers down based on the determination. Because defibrillator 12 automatically powers down after the data transmission has ended, defibrillator 12 may be left unattended during the data transmission without concern that a power source 16 of the defibrillator will be unnecessarily depleted.

As will be described in greater detail below, defibrillator 12 collects medical event information 18 during treatment of a patient (not shown in FIG. 1), and stores the medical event information in a memory 20. The data that defibrillator 12 transmits to computer 14 may include at least some of the medical event information. Computer 14 may be used to generate a report describing the treatment of the patient, sometimes referred to as an incident or “run” report, based on the medical event information. For example, a user of defibrillator 12 may be required to generate such a report using computer 14 by a local emergency medical services (EMS) system for evaluation of the timeliness of the response to the medical emergency involving the patient, and the efficacy of the treatment provided to the patient. In some embodiments, computer 14 automatically generates some or all of the run report based upon the medical event information received from defibrillator 12.

Computer 14 may be, for example, a desktop computer, a laptop computer, or a handheld computer, such as a personal digital assistant (PDA). Computer 14 may be coupled or coupleable to a computer network, such as the Internet, for distribution of received medical event information 18 or generated reports to other computers and users. For example, computer 14 may transmit a generated report to regulatory body of a local EMS organization, and one or both of the report and the received medical event information to a hospital for inclusion in the medical records of the treated patient, via the network.

Computer 14 may be located at a facility where defibrillator 12 is returned for storage after being used to respond to one or more medical emergencies, and defibrillator 12 may transmit data including medical event information 18 to computer 14 when returned to the facility. For example, computer 14 may be located at an EMS facility where ambulances and defibrillators are stored between medical emergencies. However, transmission of data from defibrillator 12 to computer 14 may occur at any time, over any distance, and when defibrillator 12 and computer 14 are at any location. For example, transmission of data from defibrillator 12 to computer 14 may occur when one or both of the defibrillator and computer are located in the field, e.g., at the location of a medical emergency, or in transit to or from that location.

In the illustrated embodiment, defibrillator 12 and computer 14 communicate wirelessly. As shown in FIG. 1, defibrillator 12 may include a transceiver 22 for wireless communication with computer 14. Transceiver 22 may, for example, take the form of an integrated circuit or circuit card with circuitry configured for wireless communication, e.g., a wireless network interface card. Computer 14 may also include a transceiver that is similar to transceiver 20 to facilitate wireless communication with defibrillator 12.

In some embodiments, defibrillator 12 and computer 14 communicate wirelessly via a radio frequency (RF) communication medium according any of a number of wireless communication standards, and transceiver 22 may include an antenna (not shown) to facilitate wireless communication with computer 14 via the RF communication medium. For example, defibrillator 12 and computer 14 may communicate wirelessly according to the Bluetooth specification set, which was promulgated by the Bluetooth Special Interest Group (SIG), and is available for download at http://www.bluetooth.org, or any one of the IEEE 802.11 specification sets promulgated by the Institute of Electrical and Electronics Engineers (IEEE). In embodiments in which the transceiver 22 takes the form of a wireless network card, the wireless network card may be compliant with one or more of these RF wireless communication standards.

In other embodiments, defibrillator 12 and computer 14 communicate wirelessly via an infrared communication medium according to, for example, one or more of the specifications promulgated by the Infrared Data Association (IrDA). Further, the invention is not limited to wireless communication and, in other embodiments, defibrillator 12 and computer 14 may communicate via a wired connection. For example, defibrillator 12 and computer 14 may communicate data serially according to one of the RS-232, universal serial bus (USB), or IEEE 1394 standards.

A processor 24 coupled to transceiver 22 controls the operation of transceiver 22 to transmit data to computer 14. Processor 24 also controls the operation of defibrillator 12 to monitor a patient, provide therapy to the patient, and generate medical event information 18 during the treatment of the patient. Processor 24 may, for example, include one or more of a microprocessor, digital signal processor (DSP), application specific integrated circuit (ASIC), field programmable gate array (FPGA), or other logic circuitry.

In addition to medical event information 18, memory 20 may include program instructions that cause processor 24 to perform the functions attributed to processor 24 herein. Accordingly, the invention also contemplates computer-readable media storing instructions to cause processor 24 to provide the functionality described herein. Memory 20 may include any of a variety of solid state, magnetic or optical media, such as random access memory (RAM), read-only memory (ROM), CD-ROM, magnetic disk, electrically erasable programmable ROM (EEPROM), or flash memory.

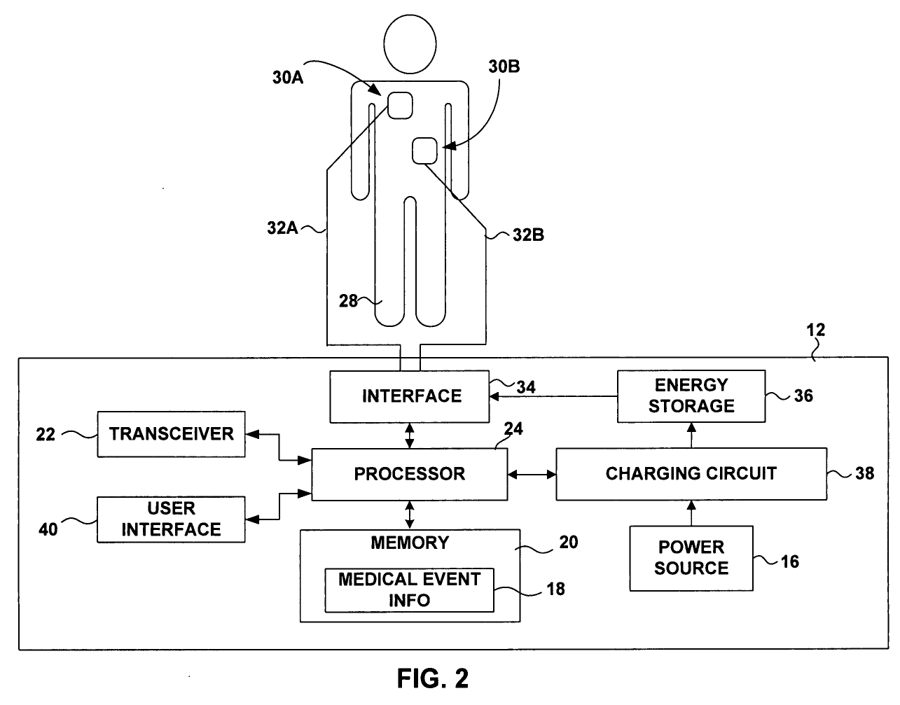

FIG. 2 is a block diagram further illustrating external defibrillator 12. In FIG. 2, defibrillator 12 is shown coupled to a patient 28 by electrodes 30A and 30B (collectively “electrodes 30”). Although two electrodes 30 are shown in FIG. 2, defibrillator 12 may be coupled to patient 28 by any number of electrodes. In some embodiments, for example, defibrillator 12 is coupled to patient 28 by twelve or more electrodes 30.

Defibrillator 12 is coupled to patient 28 in order to facilitate the treatment of patient 28, e.g., sensing electrical activity of the heart of patient 28 and delivering defibrillation pulses to patient 28 via electrodes 30. Defibrillator 12 need not be coupled to patient 28 when transmitting data to computer 14. As discussed above, defibrillator 12 may transmit data to computer 14 some time after the medical emergency at a location where the defibrillator is stored when not currently being used to respond to a medical emergency.

Electrodes 30 may include hand-held electrode paddles or adhesive electrode pads placed on the skin of patient 28. Electrodes 30 are coupled to defibrillator 12 via respective conductors 32A and 32B (collectively “conductors 32”) and an interface 34. In a typical application, interface 34 includes a receptacle, and conductors 32 plug into the receptacle.

Interface 34 includes a switch (not shown in FIG. 2) that, when activated, couples an energy storage circuit 36 to electrodes 30. Energy storage circuit 36 stores the energy to be delivered to patient 28 in the form of a defibrillation pulse. The switch may be of conventional design and may be formed, for example, of electrically operated relays. Alternatively, the switch may comprise an arrangement of solid-state devices such as silicon-controlled rectifiers or insulated gate bipolar transistors.

Energy storage circuit 36 includes components, such as one or more capacitors, that store the energy to be delivered to patient 28 via electrode set 30. Before a defibrillation pulse may be delivered to patient 30, energy storage circuit 36 must be charged. Processor 24 directs a charging circuit 38 to charge energy storage circuit 36 to a high voltage level. Charging circuit 38 comprises, for example, a flyback charger that transfers energy from a power source 16 to energy storage circuit 36.

Defibrillator 12 may be a manual defibrillator or an AED. Where defibrillator 12 is a manual defibrillator, a caregiver using defibrillator 12 may select an energy level for each defibrillation pulse delivered to patient 12. Processor 24 may receive the selection made by the caregiver via a user interface 42, which may include input devices, such as a keypad and various buttons or dials, and output devices, such as various indicator lights, a cathode ray tube (CRT), light emitting diode (LED), or liquid crystal display (LCD) screen, and a speaker. Where defibrillator 12 is an AED, processor 24 may select an energy level from a preprogrammed progression of energy levels stored in memory 20 based on the number of defibrillation pulses already delivered to patient 28.

When the energy stored in energy storage circuit 36 reaches the desired energy level, processor 24 controls user interface 40 to provide an indication to the caregiver that defibrillator 12 is ready to deliver a defibrillation pulse to patient 28, such as an indicator light or a voice prompt. The defibrillation pulse may be delivered manually or automatically. Where the defibrillation pulse is delivered manually, the caregiver may direct processor 24 to deliver the defibrillation pulse via user interface 40 by, for example pressing a button. In either case, processor 24 activates the switches of interface 34 to electrically connect energy storage circuit 36 to electrodes 30, and thereby deliver the defibrillation pulse to patient 28.

Processor 24 may modulate the defibrillation pulse delivered to patient 28. Processor 24 may, for example, control the switches of interface 34 to regulate the shape and width of the pulse. Processor 24 may control the switches to modulate the pulse to, for example, provide a multiphasic pulse, such as a biphasic truncated exponential pulse, as is known in the art.

Processor 24 may perform other functions as well, such as monitoring electrical activity of the heart of patient 28 sensed via electrodes 30. Processor 24 may determine whether the heart of patient 28 is fibrillating based upon the sensed electrical activity in order to determine whether a defibrillation pulse should be delivered to patient 28. Where a defibrillation pulse has already been delivered, processor 24 may evaluate the efficacy of the delivered defibrillation pulse by determining if the heart is still fibrillating in order to determine whether an additional defibrillation pulse is warranted. Processor 24 may automatically deliver defibrillation pulses based on these determinations, or may advise the caregiver of these determinations via user interface 40. Processor 24 may display an electrocardiogram (ECG) that reflects the sensed electrical activity via user interface 40.

Processor 24 may store an indication of the time of delivery of each defibrillation pulse delivered to patient 28 as medical event information 18 within memory 20 for patient 28. Processor 24 may also store the energy level of each pulse and other characteristics of each pulse, such as the width, amplitude, or shape, as medical event information 18 for patient 28. Processor 24 may also store a digital representation of the ECG, or a heart rate over time determined based on the electrical activity of the heart of patient 28 detected via electrodes 28 as medical event information 18 for patient 28. Further, processor 24 may control delivery of other types of therapy to patient 28 via electrodes 30, such as cardioversion or pacing therapy, and store information describing the times that such therapies were delivered and parameters of such therapies, such as cardioversion pulse energy levels and pacing rates, as medical event information 18 for patient 28.

User interface 40 may include a microphone (not shown) that detects sounds in the vicinity of defibrillator 12. Processor 24 may receive signals from the microphone and store an audio recording that includes these signals as medical event information 18 for patient 28. The audio recording may include verbal notations of a user of defibrillator 12, or conversations between the user and patient 28.

The user may mark the time of the occurrence of various events, such as the delivery of drugs or the administration of cardiopulmonary resuscitation (CPR), during the treatment of patient 28 by, for example, pressing a key or button of user interface 40 at the time when the event occurred. These event markers may also be included within medical event information 18 for patient 28. Where defibrillator 12 is more fully featured, e.g., a manual paramedic or hospital defibrillator, defibrillator 12 may also include additional sensors (not shown) coupled to processor 24, such as sensors to measure blood oxygen saturation, blood pressure, respiration, and the amount of oxygen or carbon dioxide in the air inhaled or exhaled by patient 28. Processor 24 may also store the signals generated by these sensors within memory 20 as medical event information 18 for patient 28. In other words, as examples, processor 24 may also store any of a capnograph, a plethysmograph, a blood oxygen saturation over time, a blood pressure over time, a pulse rate over time determined based on measured blood pressure, end tidal carbon dioxide measurements, and/or measurements of the fraction of carbon dioxide in air inspired or expired within memory 20 as medical event information 18 for patient 28. Processor 24 may begin to store medical event information 18 when defibrillator 12 is powered on to respond to a medical emergency.

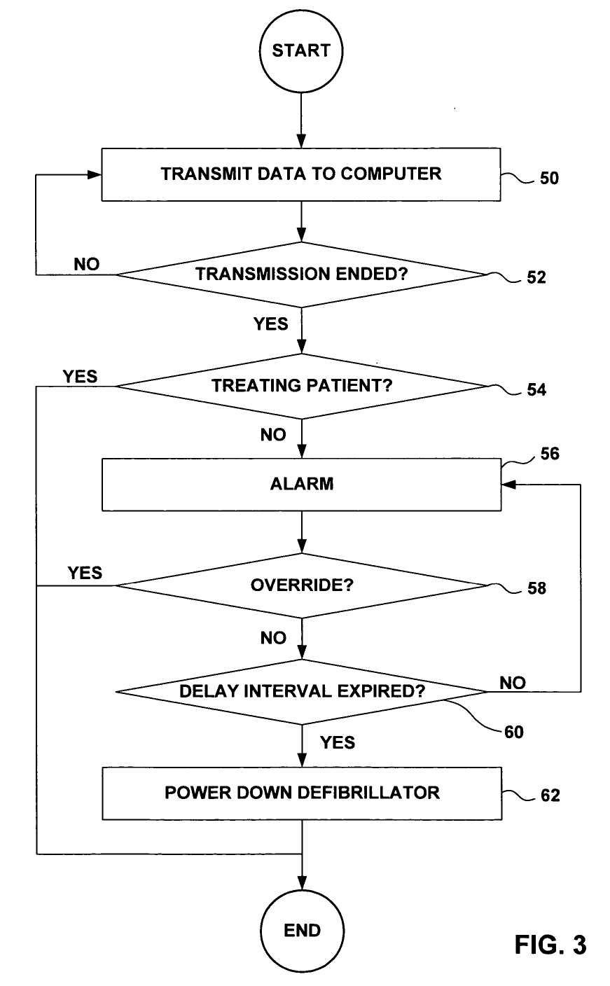

FIG. 3 is a flow diagram illustrating an example method for determining whether to automatically power down after a data transmission that may be performed by defibrillator 12. In the illustrated example, defibrillator 12 transmits data to computer 14 and, more particularly, processor 24 transmits data from memory 20 to computer 14 via transceiver 22 (50). As described above, defibrillator 12 may transmit data to computer 14 after patient 28 has been treated, and defibrillator 12 has been returned to a storage location. Further, the data may include at least some of the medical event information 18 recorded during the treatment of patient 28. For example, processor 24 may receive a command to enter an archive mode in which medical event information 18 may be accessed, selections of medical event information 18 for one or more patients, and a command to begin transmitting data including the selected medical event information to computer 14 from a user of defibrillator 12 via user interface 40. In response to these commands and selections, processor 24 may transmit data including the selected medical event information 18 from memory 20 to computer 14 via transceiver 22.

Processor 24 determines when the transmission of data to computer 14 has ended (52) such that defibrillator 12 may be powered down. In some embodiments, for example, processor 24 receives a signal from computer 14 via transceiver 22, by which computer 14 acknowledges receipt of the entire data transmission. In such embodiments, processor 24 may determine that the data transmission has ended based on receipt of the signal. By automatically powering down defibrillator 12 after the data transmission has ended, processor 24 may allow the user to leave defibrillator 12 during the data transmissions, e.g., after entering the commands to initiate the data transmission, without concern that power source 16 of defibrillator 12 will be unnecessarily depleted.

However processor 24 may also transmit data to computer 14 or another device at times or in situations when it would not be appropriate to power down defibrillator 12, such as when defibrillator is currently being used to treat a patient. Consequently, in some embodiments, processor 24 additionally determines whether it is appropriate to power down defibrillator 12 when the data transmission is complete, and powers down the defibrillator based on the determination. For example, in the embodiment illustrated by FIG. 3, processor 24 determines whether defibrillator 12 is currently being used to treat a patient (54). Processor 24 may determine whether defibrillator 12 is currently being used to treat a patient by, for example, determining whether defibrillator 12 is in a therapy mode, as opposed to archive mode, or receiving an indication from interface 34 that electrodes 30 are coupled to a patient. If processor 24 determines that defibrillator 12 is not currently being used to treat a patient, processor 24 may power down defibrillator 12 after the data transmission has ended.

To further ensure that defibrillator 12 is not inappropriately powered down after a data transmission has ended, processor 24 may delay powering down defibrillator 12 for interval after determining that the data transmission has ended. Processor 24 may provide an alarm via user interface 40 during the interval to, for example, alert users of the defibrillator 12 that it will be powering down shortly unless the scheduled power down is overridden (56). Processor 24 may, for example, activate lights, provide an audible alarm or message via a speaker, or provide a message via a display of the user interface. Audible or displayed messages may include a time remaining until defibrillator 12 is powered down, and an indication of how to override the power down. The length of the delay interval and types of alarms provided during the delay interval may be programmed by a user via user interface 40, and stored in memory 20.

If processor 24 determines that the delay interval has expired without receiving an override command via user interface 40 (60), processor 24 powers down defibrillator 12 (62). Processor 24 may power down defibrillator 12 by powering off defibrillator 12. In other embodiments, processor 24 powers down defibrillator 12 by placing defibrillator 12 in a low power state in which, for example, diagnostic and other low power consumption activities may occur.

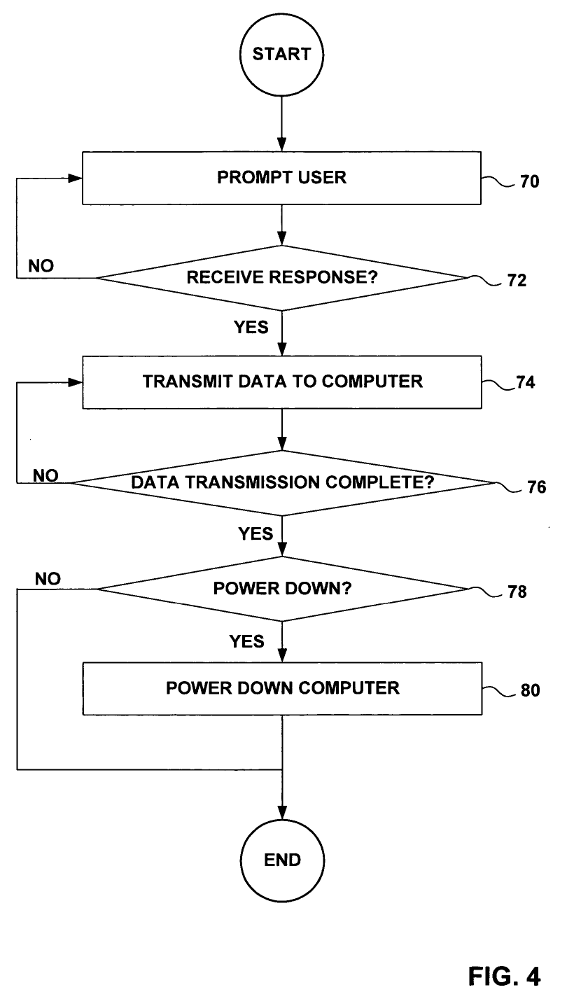

FIG. 4 is a flow diagram illustrating another example method for determining whether to automatically power down after a data transmission that may be performed by defibrillator 12. In particular, FIG. 4 illustrates an example method in which processor 24 receives an indication as to whether to power down defibrillator 12 at the end of a data transmission from a user of the defibrillator via user interface 40 prior to the end of the data transmission. In such embodiments, processor 24 powers down defibrillator 12 at the end of the data transmission if directed to by the user.

In the illustrated example, processor 24 prompts the user for the indication via user interface 40, e.g., a display of the user interface (70). For example, processor 24 may prompt the user after receiving a command to enter an archive mode in which medical event information 18 may be accessed, selections of medical event information 18 for one or more patients, and a command to begin transmitting data including the selected medical event information to computer 14. When processor 24 receives a response from the user via user interface 40 (72), processor 24 begins transmitting data from memory 20 to computer 14 via transceiver 22 (74). In other embodiments, processor 24 may begin transmitting data prior to receiving the response from the user. When processor 24 determines that the data transmission is complete (76), processor 24 determines whether the user indicated that defibrillator 12 should be powered down after the data transmission (78). If the user indicated that the defibrillator should be powered down, processor 24 powers down defibrillator 12 (80).

Various embodiments of the invention have been described. For example, an external defibrillator that transmits data to a computer, determines when the data transmission has ended, and powers down based on the determination has been described. Various methods for automatically powering down after a data transmission has ended that may be performed by an external defibrillator, and computer-readable media for causing a programmable processor of an external defibrillator to perform such methods have also been described. Because an external defibrillator as described is capable of automatically powering down after a data transmission has ended, such a defibrillator may be left unattended during the data transmission without concern that its power source will be unnecessarily depleted.

However, one skilled in the art will appreciate that various modifications may be made to the described embodiments without departing from the scope of the claimed invention. For example, although described herein in the context of an external defibrillator, any type of portable medical device may automatically power down after transmission of data to a computer as described herein. Other examples of portable medical devices that may automatically power down after transmission of data to a computer include drug delivery devices or monitoring devices that do not provide therapy. Computers, such as computers used to provide or record information during the treatment of a patient, may also be portable medical devices that automatically power down after transmission of data to another computer according to the invention. Further, although each of these example types of portable medical devices may collect, store and transmit medical event information in the manner described herein with respect to external defibrillators, the invention is not limited to transmission of data that includes medical event information.

Moreover, although described herein in the context of transmission of data to a computer, a portable medical device may automatically power down according to the invention after transmitting data to any type of device, including another medical device. For example, a first responder to a medical emergency may use an automated external defibrillator (AED) to treat a patient until Advanced Cardiac Life Support (ACLS) trained emergency medical personnel, e.g. paramedics, arrive at the scene of the medical emergency with a more fully featured defibrillator/monitor. The AED may transmit data, including medical event information that is has collected during the treatment of the patient, to the other external defibrillator for eventual inclusion in a run report or the patient's medical records, and automatically power down when the data transmission has ended.

Additionally, a portable medical device according to the invention may power down after transmission of data to a different type of medical device. For example, an external defibrillator according to an embodiment of the invention may power down after transmission of data to a vital signs monitor that was also used during treatment of a patient. These and other embodiments are within the scope of the following claims.

1. A method comprising:
transmitting data from a memory of a portable medical device to another device;
determining whether the data transmission has ended; and
automatically powering down the portable medical device based on the determination.

2. The method of claim 1, wherein determining whether the data transmission is ended comprises:
receiving a signal from the other device indicating receipt of the data transmission; and
determining whether the data transmission has ended based on receipt of the signal.

3. The method of claim 1, further comprising determining whether the portable medical device is currently being used for treatment of a patient, and wherein automatically powering down the portable medical device comprises automatically powering down the portable medical device based on the determination of whether the portable medical device is currently being used for treatment of the patient.

4. The method of claim 3, wherein determining whether the portable medical device is currently being used for treatment of a patient comprises detecting whether the portable medical device is connected to the patient.

5. The method of claim 3, wherein determining whether the portable medical device is currently being used for treatment of a patient comprises determining whether the portable medical device is in a treatment mode.

6. The method of claim 1, further comprising receiving an input from a user prior to an end of the data transmission indicating whether to power down the portable medical device when the data transmission has ended, and wherein automatically powering down the portable medical device comprises automatically powering down the portable medical device based on the input.

7. (canceled)

8. The method of claim 1, further comprising determining that the data transmission has ended, and wherein automatically powering down the portable medical device comprises automatically powering down the portable medical device an interval after the determination that the data transmission has ended.

9. (canceled)

10. The method of claim 8, further comprising determining whether an override command is received from a user during the interval, and wherein automatically powering down the portable medical device comprises automatically powering down the portable medical device based on the determination of whether the override command was received during the interval.

11. The method of claim 1, wherein transmitting data from a memory of a portable medical device to another device comprises transmitting data from the memory of an external defibrillator to the other device.

12. (canceled)

13. The method of claim 11, further comprising:
collecting information during treatment of a patient with the external defibrillator; and
storing the collected information as data within the memory of the portable medical device, and
wherein transmitting data comprises transmitting the collected information.

14-15. (canceled)

16. A portable medical device comprising:
a memory that stores data;
communication circuitry; and
a processor to control the communication circuitry to transmit data from the memory to another device, determine whether the data transmission has ended, and automatically power down the portable medical device based on the determination.

17. The portable medical device of claim 16, wherein the processor receives a signal from the other device via the communication circuitry, the signal indicating receipt of the data transmission, and determines whether the data transmission has ended based on receipt of the signal.

18. The portable medical device of claim 16, wherein the processor determines whether the portable medical device is currently being used for treatment of a patient, and automatically powers down the portable medical device based on the determination of whether the portable medical device is currently being used for treatment of the patient.

19. The portable medical device of claim 18, further comprising monitoring circuitry that detects whether the portable medical device is connected to the patient, wherein the processor receives a signal from the monitoring circuitry that indicates whether the portable medical device is connected to the patient, and determines whether the portable medical device being used for treatment of the patient based on the signal.

20. The portable medical device of claim 19,
wherein the monitoring circuitry is coupled to electrodes, and detects whether the electrodes are connected to the patient, and
wherein the processor receives a signal from the monitoring circuitry that indicates whether the electrodes are connected to the patient, and determines whether the portable medical device being used for treatment of the patient based on the signal.

21. The portable medical device of claim 18, wherein the processor determines whether the portable medical device is in a treatment mode.

22. The portable medical device of claim 16, further comprising a user interface, wherein the processor receives an input from a user prior to an end of the data transmission via the user interface, the input indicating whether to power down the portable medical device when the data transmission has ended, and automatically powers down the portable medical device based on the input.

23. (canceled)

24. The portable medical device of claim 16, wherein the processor determines that the data transmission has ended, and automatically powers down the portable medical device an interval after the data transmission has ended.

25. The portable medical device of claim 24, further comprising a user interface, wherein the processor directs the user interface to provide an alarm during the interval.

26. The portable medical device of claim 24, further comprising a user interface, wherein the processor determines whether an override command is received from a user via the user interface during the interval, and automatically powers down the portable medical device based on the determination of whether the override command was received during the interval.

27. The portable medical device of claim 16, wherein the portable medical device comprises an external defibrillator.

28. The portable medical device of claim 27, wherein the processor controls the communication circuitry to transmit the data to a computing device.

29. The portable medical device of claim 27, wherein the processor collects information during treatment of a patient with the external defibrillator, stores the collected information as data within the memory of the external defibrillator, and controls the communication circuitry to transmit the collected information from the memory to the other device.

30. The portable medical device of claim 27, wherein the processor collects at least one of an electrocardiogram of the patient, a capnograph of the patient, a plethysmograph of the patient, a heart rate of the patient over time, a pulse rate of the patient over time, a blood oxygen saturation of the patient over time, a blood pressure of the patient over time, end tidal carbon dioxide measurements of the patient, measurements of the fraction of carbon dioxide in air inspired or expired by the patient, an indication of one or more therapies delivered to the patient, an indication of times at which the one or more therapies were delivered to the patient, or an audio recording during treatment of a patient with the external defibrillator.

31-42. (canceled)

43. A portable medical device comprising:
means for transmitting data from a memory of a portable medical device to another device;
means for determining whether the data transmission has ended; and
means for automatically powering down the portable medical device based on the determination.

44. (canceled)

45. The portable medical device of claim 43, further comprising means for determining whether the portable medical device is currently being used for treatment of a patient, and wherein the means for automatically powering down the portable medical device comprises means for automatically powering down the portable medical device based on the determination of whether the portable medical device is currently being used for treatment of the patient.

46. The portable medical device of claim 43, further comprising
means for collecting information during treatment of a patient with the external defibrillator; and
means for storing the collected information as data within the memory of the portable medical device, and
wherein means for transmitting data comprises means for transmitting the collected information.
